(19) United States
(12) Patent Application Publication
(10) Pub. No.: US 2007/0247454 A1
(43) Pub. Date: Oct. 25, 2007

(54) 3D visualization with synchronous X-ray image display

(76) Inventors: Norbert Rahn, Forchheim (DE); Jan Boese, Eckental (DE)

Correspondence Address: BRINKS HOFER GILSON & LIONE, P.O. BOX 10395, CHICAGO, IL, 60610, US

(21) Appl. No.: 11/406,723

(22) Filed: Apr. 19, 2006

(51) Int. Cl. G06T 15/00

(52) U.S. Cl. 345/419

(57) ABSTRACT

A data processing system and method for multi-modal viewing of medical image visualization is described. The system includes an image display device operable to display an on-the-fly (“fly”) visualization of a three dimensional (3D) data set, and a live X-ray image, where the parameters of the “fly” visualization are adjusted so that the “fly” visualization image has a correspondence to the live X-ray image. The method includes recording a three dimensional (3D) data set, and a corresponding live X-ray image; rendering a “fly” visualization of the 3D data set; adjusting the attributes of the “fly” visualization to achieve a correspondence with the live X-ray image; and, simultaneously displaying the “fly” visualization image and the live X-ray image.

### TECHNICAL FIELD

The present application relates to a method of synchronous display of an X-ray image with a three-dimensional “on-the-fly” visualization image

### BACKGROUND

In minimally invasive procedures, such as catheter interventions in the course of electrophysiological procedures, X-ray systems are used to visualize catheters.

In the X-ray images, an ablation catheter which may be used to destroy tissue, can be visualized. However the morphology of the heart cannot always be replicated with sufficiently high quality in the X-ray images. It is helpful therefore, during the electrophysiological procedure, to have, in addition to the two-dimensional X-ray images, a 3D visualization of the cardiac morphology. Such data may be generated from image data obtained with a three-dimensional imaging technique. Computerized tomography (CT), magnetic resonance imaging (MR), heart-X-ray rotation angiography, and 3D ultrasound are examples. A technique of a group of related techniques is often termed a “modality.”

The 3D morphology of the heart (or of the chamber of the heart to be treated) can be visualized in such a way that the internal morphology of, for example, the chamber of the heart to be treated could be visualized in terms of its location, scaling, orientation and from various viewing perspectives, similarly to the image contents visualized in the live X-ray image.

### SUMMARY

A data processing system for multi-modal view of medical image visualization is described, including an image display device operable to display an on-the fly (“fly”) visualization of a three dimensional (3D) data set, and a corresponding live X-ray image, where the parameters of the “fly” visualization are adjusted so that the “fly” visualization image has a correspondence to the live X-ray image.

In another aspect, a method of multi-modal view visualization of medical images is described, the method including recording a three dimensional (3D) data set, and a corresponding live X-ray image; rendering a “fly” visualization of the 3D data set; adjusting the attributes of the “fly” visualization to achieve a correspondence with the live X-ray image; and, simultaneously displaying the “fly” visualization image and the live X-ray image.

### BRIEF DESCRIPTION OF THE DRAWINGS

FIG. 1 is a simplified block diagram showing the relationship of a 3-D imaging modality, live X-ray equipment, and other components;

FIG. 2 is a three-dimensional (3D) cardiological image obtained by computerized tomography (CT);

FIG. 3 is an image of the left atrium chamber of the heat, obtained by segmentation of the CT data;

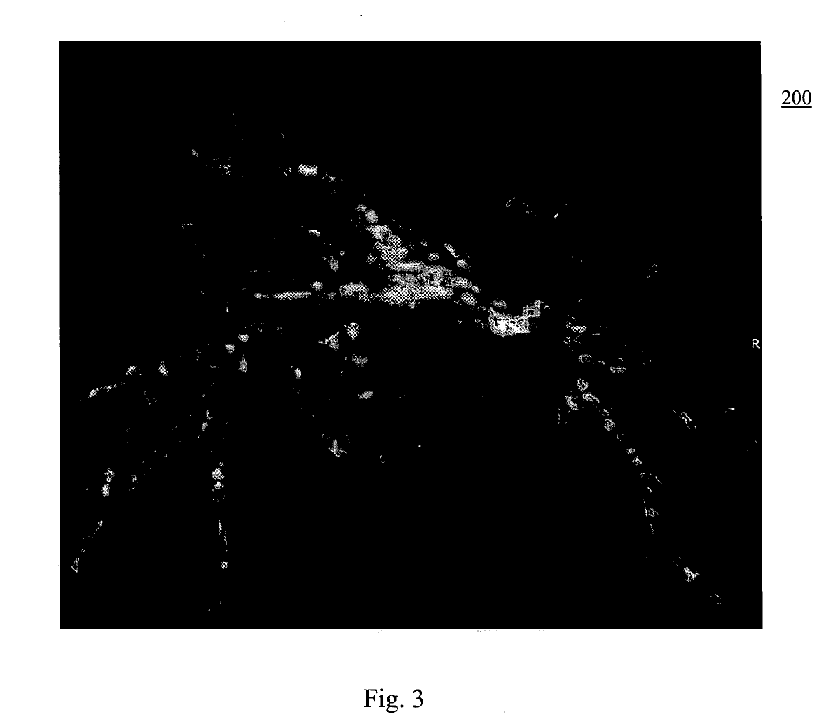

FIG. 4 is on-the-fly (“fly”) visualization image of the left atrium chamber of the heart showing 4 pulmonary veins, with a projection point of view located in the interior of the chamber of the heart;

FIG. 5 is a simulation of a simultaneous display of an on the fly X-ray image, EKG data and a “fly” visualization image; and

FIG. 6 shows the relationship of the projection geometry of the X-ray system, and corresponding parameters of the “fly” visualization image.

### DESCRIPTION

Exemplary embodiments may be better understood with reference to the drawings, but these embodiments are not intended to be of a limiting nature. Like numbered elements in the same or different drawings perform similar functions.

A combination of hardware and software to accomplish the tasks described herein is termed a platform. The instructions for implementing processes of the platform, the processes of a client application, or the processes of a server are provided on computer-readable storage media or memories, such as a cache, buffer, RAM, removable media, hard drive or other computer readable storage media. Computer readable storage media include various types of volatile and nonvolatile storage media. The functions, acts tasks or displayed images illustrated in the figures or described herein are executed or produced in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination, and may be displayed by any of the visual display techniques as are known in the art, including virtual reality, LCD displays, plasma displays, projection displays and the like. Processing strategies may include multiprocessing, multitasking, parallel processing, distributed processing, and the like. The instructions may be stored on a removable media device for reading by local or remote systems. In another aspect, the instructions may be stored in a remote location for transfer through a computer network, a local or wide area network or over telephone lines. In a further aspect, the instructions are stored within a given computer or system.

Provision is made for obtaining, converting and storing the necessary data, and for the archiving of such data. Further, the overall architecture makes provision for the various components to be geographically distributed while operating in a harmonious manner. Data may be stored in the same or similar media as is used for instructions.

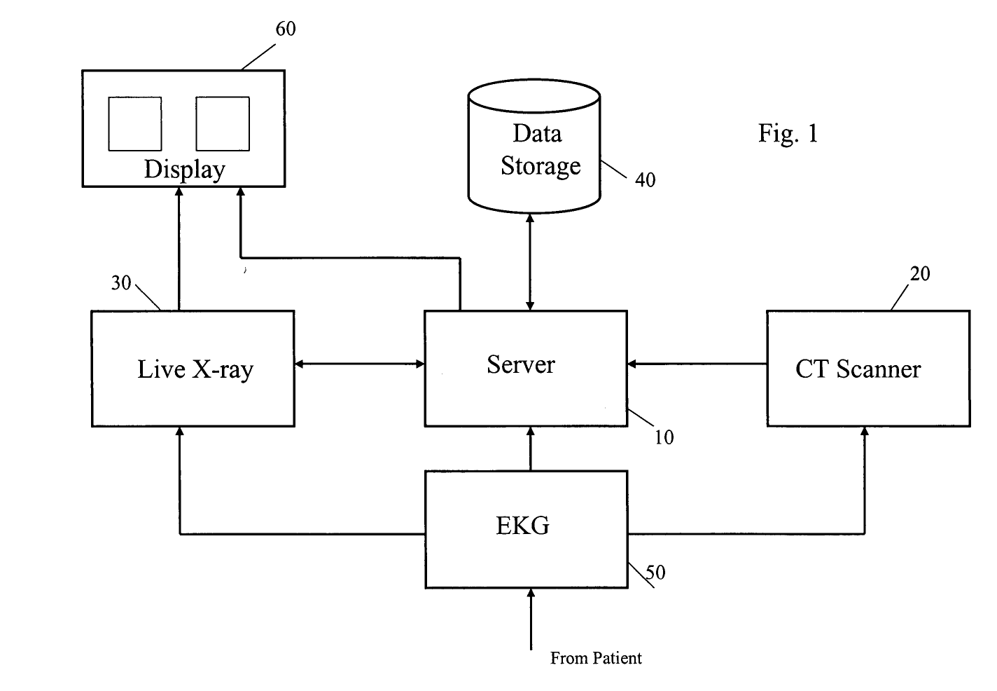

FIG. 1 shows elements of a system for obtaining and displaying data for 3D Visualization with Synchronous X-Ray Image Display. A CT scanner 20 is an example of an imaging modality capable of providing data for producing “on-the-fly” images of a patient. The output of the CT scanner 20 may be processed by an computer (not shown) or by the server 10 and stored as data on a computer readable medium such as a disk drive, RAM memory or the like, either locally to the treatment room of communicating with the server 10 and other equipment over a network (not shown). The stored data from the CT scanner 20 may be synchronized with bodily functions of the patient, for example, by use of an EKG system 50 connected to the patient while the CT scan is being performed, and to the real-time X-ray equipment used during a procedure. The live X-ray equipment produces a displayable image at a frame rate sufficient to permit performing a procedure, and is displayed on a display 60. The display may have more than one display surface, or a display surface may be partitioned so that multiple images may be simultaneously displayed, either separately or in a superimposed fashion. The live X-ray data from the live X-ray machine 30 may be displayed immediately for use, and may also be sent to the server, to be stored for retrospective analysis.

In an aspect, the EKG equipment may be connected to the patient to cause the live X-ray images to be obtained at a time corresponding to a previously obtained CT scan where the phase of the cardiac cycle may be identified and used to obtain the X-ray images in a manner synchronous with the phase of the previously obtained CT scan data.

A method of forming and displaying 3D and 4D “on-the-fly” visualization of data from various imaging modalities simultaneously with the live X-ray image is described. The visualization is presented in a form such that the parameters of the “on-the-fly” visualization (e.g., location, current point of view, opening angle, orientation, and/or the like) correspond to the current projection geometry of the X-ray system by which live X-ray image is generated.

Examples of electrophysiological treatments in which a synchronous visualization of an X-ray image and of a perspective “on-the-fly” visualization generated from image data of a three-dimensional imaging modality (CT, MRI, heart-X-ray rotation angiography 3D ultrasound) appear appropriate are, for example, ablation procedures in the case of arrhythmias, such as atrial fibrillation, atrial flutter, AVNRT, SVT, VT, and the like.

A real-time X-ray image may be obtained in a manner similar to conventional flouoscopy, where the X-ray image is visualized using a medium responsive to the X-rays and emitting visual light. Typically the X-ray detector is a semiconductor device having suitable spatial resolution and converting the X-ray energy into electronic data which may be scanned and displayed on a computer monitor. The resolution, frame rate, and other characteristics depend on the requirements of a specific medical application, including total patient X-ray dose, coordination with manipulation of medical instruments, or speed of bodily functions to be monitored and the like. In some examples, a frame speed of 30frames per second may be achieved.

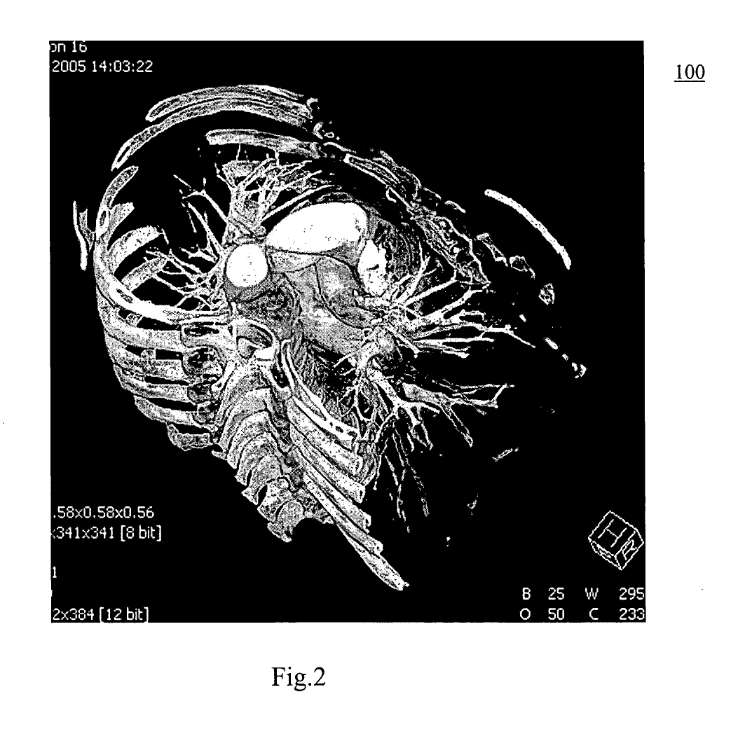

Three-dimensional (3D) cardiological image data are generated prior to commencing an electrophysiological procedure by a modality such as one of CT, MRI, heart-X-ray rotation angiography, or 3D ultrasound techniques. FIG. 2 shows an example 3D image 100 (i.e., three-dimensional representation) generated from 3D data. Where such 3D images 100 are obtained intraprocedurally, heart-X-ray rotation angiography and 3D ultrasound may be used, as examples. The 3D image data can also be generated multiple times during the procedure as may be needed. The 3D data is converted to a regular 3D grid, formatted as a plurality of slices or image planes, formatted in a scan pattern or has another spatial format.

The surface morphology of the chamber of the heart to be treated is extracted from the 3D image data. FIG. 2 shows a 3D segmented image 200 generated from the extracted data. Various extraction techniques are known in the art for producing an image of an organ, or portion thereof, separated from the surrounding body tissues, bones and fluids. Such a separation may be termed “segmentation” of the image. Interfering structures which may be contained in the source 3D image data, such as bones and regions treated with contrast enhancing materials, may be eliminated from the images presented by data and image processing, as is known in the art. The segmented image 200 of the organ or region to be treated may be represented in terms of the geometry and details of the heart chamber, for example, by adjusting the parameters of the segmentation process.

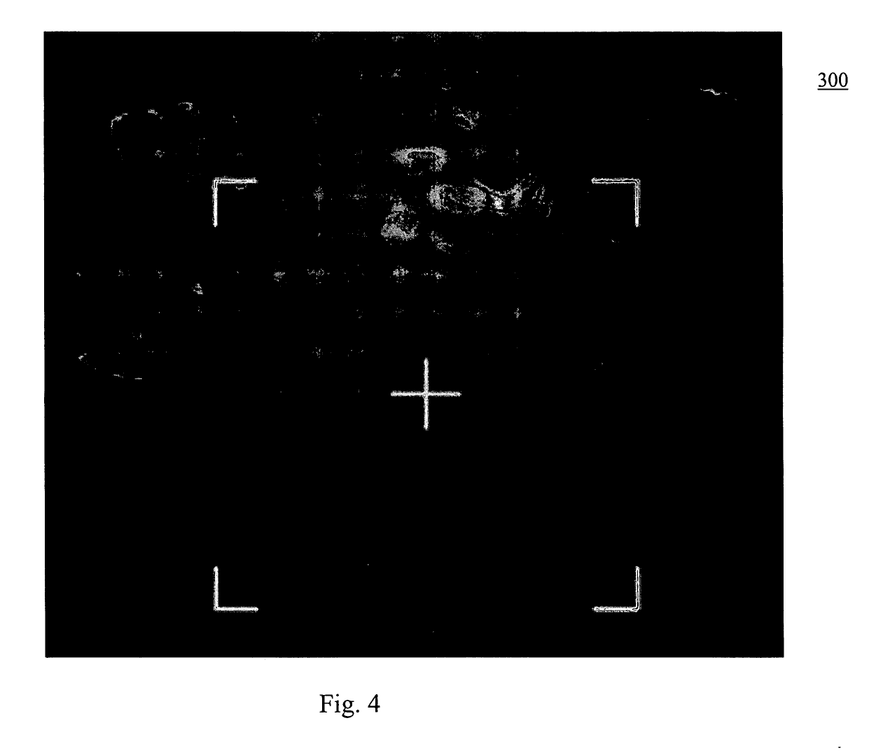

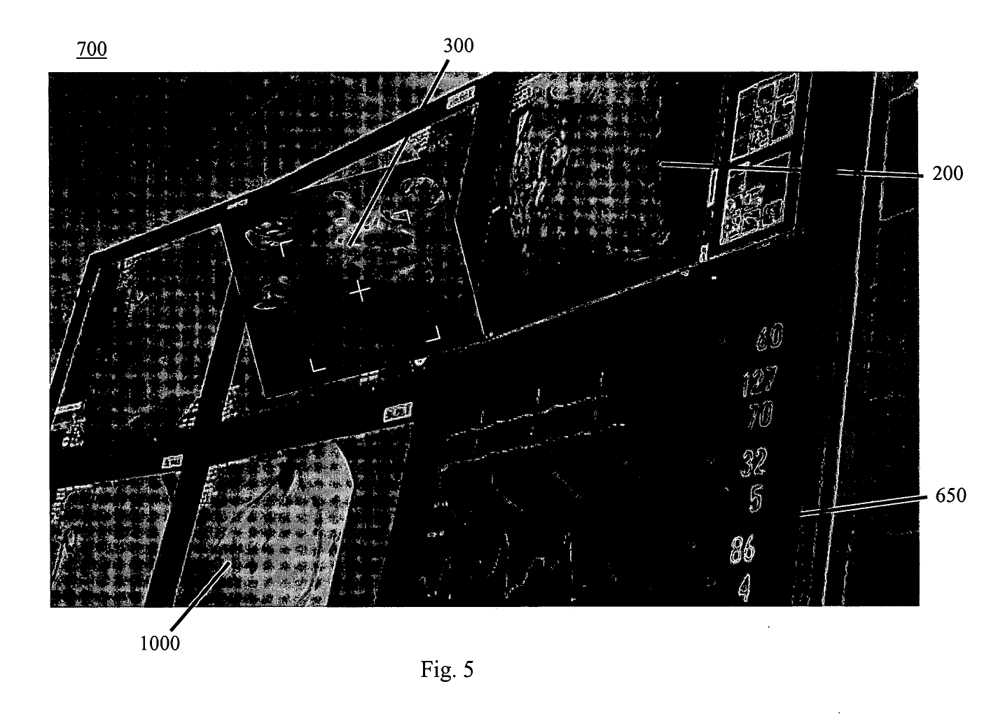

FIG. 4 shows a three-dimensional representation 300 generated from the 3D data for “on-the-fly” visualization. For example, slices are obtained in a spiral CT scan. The data is segmented to extract image data of the body part of interest. The data is rendered as a 2D image (3D representation 300) as if produced by a camera rendering an image. Any now known or later developed rendering technique may be used, such as projection or surface rendering. By appropriate adjustment of presentation parameters, such as the point of view 900, the projection geometry (opening angle) 920 and the far clip plane 910 (see FIG. 5), the 3D representation 300 may be of an outer surface of an organ, or the interior thereof, and the operator may adjust the presentation parameters so as to “fly” through the interior space. This type of image visualization and display allows visualization of body parts such as the lung, intestines, colon, and the like.

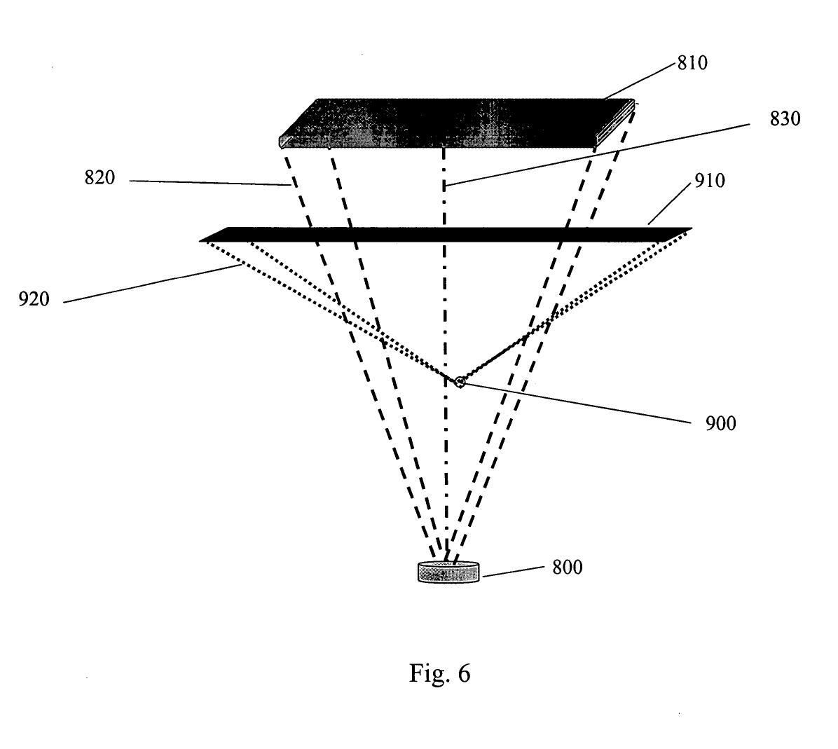

The parameters for rendering the image for viewing during the procedure may be transformed to adjust the position of the point of view, opening angle, orientation/viewing direction, the near clip plane and/or far clip plane such that the “fly” visualization image may correspond in size, location and/or orientation to a live X-ray image 1000 (see FIG. 5). Corresponding size, location and orientation include a same, overlapping, or similar size, location and orientation. As shown in FIG. 6, a corresponding size, location and orientation may provide for aligned viewing axes, but different opening angles for one image being similar, but slightly larger, view of overlapping locations. Since the X-ray image incorporates information from different depths, the “fly” visualization may correspond to the X-ray image but only represent particular depths. Corresponding views may also include differences, such as viewing from different angles. One of the angles depends on the other angle, so views may be different but correspond.

After adjusting the images so that the “fly” visualization corresponds to the X-ray image, the images may be maintained in this relationship by the processing system. That is, when the projection geometry of the X-ray system changes by, for example, rotating the X-ray machine with respect to the axis of a patient, the parameters of the “on-the-fly” visualization are automatically adapted to correspond to the X-ray system. In this aspect, the projection geometry of the X-ray system may be ascertained by the use of position sensors on the C-arch supporting the X-ray source and detector, on the C-arch support and the patient support table. In the alternative, where the parameters of the “fly” visualization are changed by the user so as to obtain another view, the position of the X-ray system with respect to the patient may be controlled through a servomechanism system.

The X-ray source 800 and the X-ray detector 810 are shown schematically with respect to the X-ray system projection geometry 820, and the central axis of the X-ray device 830 in FIG. 6. In this manner, the “fly” visualization provides further definition of the morphology of the body structure to enable better interpretation of the live X-ray.

Other factors which may affect the X-ray projection geometry may be table height and the position of the X-ray tube and detector. The visualization rendering may be adjusted to account for any variation or possible X-ray projection geometry. A range of possibilities is provided, but steps or limited visualization may be used. For example, one of only particular or set geometries for the visualization is selected to best correspond to the X-ray projection geometry.

In another aspect, when the position of a catheter (in particular, an ablation catheter in electrophysiological procedures) is known, as when using a live X-ray display, the point-of-view of the “on-the-fly” visualization may be selected such that the “fly” visualization is effected from the viewpoint of the current catheter position. This provides the operator with more information as to the relationship of the catheter to the surface of the interior or the heart or the other organ or body structure. Alternatively, the point of view of the “on-the-fly” visualization can also be selected to be offset slightly to the rear of the current catheter position, so that the position and orientation of the catheter can be incorporated into the visualization, by adding a synthetic image of the catheter to the “fly visualization”. In this manner, the “fly visualization” appears to actually be imaging the catheter in the modality that was used to obtain the slices for constructing the 3D image.

In another aspect, instead of altering the viewpoint of the 3D visualization in accordance with the positioning of the C-arch geometry of the X-ray system, the operator may act on the parameters of the “on-the-fly” visualization (in particular the viewing direction) for instance by means of a user interface described in US application entitled “Intuitive User Interface for Endoscopic View Visualization”, U.S. Ser. No. 11/227,807, filed on Sep. 15, 2005, which is assigned to the assignee of the present application, and which is incorporated herein by reference. When the parameters of the “fly” visualization image are changed, the C-arch geometry of the X-ray system is changed accordingly, so that the live X-ray image and the 3D “fly” visualization remain coordinated.

The “fly” visualization 300 and the live X-ray image 1000 may be displayed simultaneously on a monitor, video display or similar means of displaying computer-generated images, as are known in the art. Such a display, as simulated in FIG. 5, may also include other medical data, as represented by an EKG trace 650. This display may be the display of the live X-ray unit, a device used to acquire the 3D data, a workstation or another imaging device. The user may also set a certain desired difference between the projection geometry of the X-ray system and the geometry of the “fly” visualization. For instance, the electrophysiologist may elect an orientation of the visualization rotated by 90° relative to the X-ray image. Such a rotation may make it possible for the electrophysiologist to continue using a typical C-arch (not shown) angular position of an X-ray device while the 3D visualization reproduces the morphology from a more suitable viewing angle. It is also possible to enlarge the morphology in the “fly” visualization by a multiplicative factor relative to the projection in the X-ray image, and this may be used, for example, where the position of the catheter as obtained from the X-ray system is synthetically shown in the “fly” visualization.

The generation of the 3D visualization image data may be from 4D image data, with the fourth dimension representing a chronological dimension (that is, time). A cardiological 4D image data set may allow visualizations of the heart in different phases of the cardiac cycle. The association of the various images to be “fly” visualized with the stage of the cardiac cycle may be made by the use, for example, of an EKG signal. Correspondingly, a particular phase in the cardiac cycle may be recorded using a particular aspect of the EKG signal to initiate recording of the live X-ray image so that only X-ray images of an identified phase of the cycle are recorded. The corresponding 3D image data can then be selected from the 4D image data, using the phase data, so that after alignment of the images of the “fly” visualization and the live X-ray, the 3D images for other phases of the cardiac cycle may also be used. Alternatively, the 3D image selected from the 4D image data, and associated with a specific phase of the cardiac cycle, may be used to control the time when the live X-ray data is recorded.

If 4D image data are to be used for “fly”visualization then, for each of the cardiac cycle phases, a surface extraction (segmentation) of the chamber of the heart, other organ or other region to be treated is performed. In this process, the segmentation can be facilitated by providing that existing segmentation results from a cardiac cycle phase can be used as a starting value for a chronologically adjacent cardiac cycle phase. For instance, the already-extracted surface of one cardiac cycle phase can be varied by deformation such that it represents an optimal segmentation for an adjacent cardiac cycle phase. Particularly if optimization-based segmentation algorithms are used, this may lead to more computationally efficient segmentation, with fewer artifacts, when producing sequences of 3D image data sets.

FIG. 6 schematically shows the adaptation of the parameters (e.g., point of view 900, viewing direction, opening angle 920, projection area and far clip plane 910,) of the “on-the-fly” visualization to the projection geometry of the X-ray system, in order to obtain comparable projections of the chamber to be treated. The far clip plane 910 corresponds to a slice for generating a two-dimensional image. For 3D rendering, the far clip plane 910 may not be provided, such as for surface or projection rendering with values associated with different depths in a viewing direction. Knowledge of the position and orientation of the chamber of the heart relative to the projection geometry of the X-ray system may provide more useful determination of the parameters. For this purpose, it may be assumed as an approximation that the center of the chamber of the heart is located at the isocenter of the X-ray system, and that the orientation of the patient relative to the X-ray system is approximately known from the entries in the DICOM (DIgital COmmunications in Medicine) header of the 3D image data set recorded by the modality selected as the data source. By means of this orientation, the viewing direction can be adapted to the “on-the-fly” visualization. Only those parts of the image volume between the near and far clipping planes are rendered as the displayed image. Typically, objects at the near clipping plane are distinct and crisp, objects at the far clipping plane maybe blended into the background.

Although the point of view of the “on-the-fly” visualization relative to the projection geometry of the X-ray system may not be known with any precision, the point of view and the opening angle can be selected such that the entire segmented chamber of the heart is projected at approximately the same scale as in the corresponding X-ray image and in a comparable orientation. These parameters can be changed at any time by the user.

For a fixed set of parameters of the “on-the-fly” visualization, for various “on-the-fly” visualizations (which correspond to various cardiac cycle phases) may be visualized and viewed as a sequence, providing that segmentations of the 4D image data set in various cardiac cycle phases are available. As a result, a 4D “on-the-fly” visualization is created, by which the chronological variability of the endiocardium of a chamber of the heart is visualized. This visualization may be made, for instance, from the viewpoint of the catheter. Moreover, the various individual “on-the-fly” visualizations of a defined cardiac cycle phase can then be synchronized, using the EKG as a synchronizing means, with the 2D live X-ray image shown.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. In a data processing system for multi-modal view visualization, an improvement comprising:
an image display device operable to display a visualization from a three dimensional (3D) data set, and a corresponding live X-ray image,
wherein the parameters of the visualization are adjusted so that the visualization image has a correspondence to the live X-ray image.

2. The system of claim 1, wherein the visualization is rendered from 3D imaging modality data extracted by segmentation.

3. The system of claim 2, wherein the data extracted by segmentation represents a heart or a portion thereof.

4. The system of claim 2, wherein the 3D imaging modality data is computerized tomography (CT) , magnetic resonance (MR), heart-X-ray rotation angiography, or 3D ultrasound data.

5. The system of claim 1, wherein the visualization and the live X-ray image are displayed simultaneously.

6. The system of claim 3, wherein the visualization image includes a representation of a catheter, the representation being at a location as determined from the live X-ray.

7. The system of claim 5, wherein a near cut plane is positioned at a distance more distal than the catheter from a surface of the heart.

8. The system of claim 1, wherein the correspondence between the visualization image and the live X-ray image is maintained when the display parameters of the visualization is changed.

9. The system of claim 1, wherein the correspondence between the visualization image and the live X-ray image is maintained when a projection geometry of an X-ray apparatus is changed.

10. The system of claim 1, wherein the 3D data set is obtained at a plurality of times.

11. The system of claim 10, wherein a subset of the plurality of times represents phases of a cardiac cycle.

12. The system of claim 11, wherein live X-ray image is recorded and displayed for one of the phases of the cardiac cycle.

13. The system of claim 1, wherein the live X-ray is recorded at a time corresponding to a particular phase of the cardiac cycle.

14. The system of claim 13, wherein the visualization corresponds to data recorded at the particular phase of the cardiac cycle corresponding to the live X-ray data.

15. A method of multi-modal view visualization, the method comprising:
recording a three dimensional (3D) data set;
generating a live X-ray image;
rendering a visualization of the 3D data set;
simultaneously displaying the visualization image and the live X-ray image; and
adjusting the attributes of the visualization to achieve a correspondence with the live X-ray image.

16. The method of claim 15, wherein the correspondence between the visualization image and the live X-ray image is maintained when the attributes of the visualization are adjusted.

17. The method of claim 15, wherein the correspondence between the visualization image and the live X-ray image is maintained when the orientation of an X-ray device is changed.

18. The method of claim 15, wherein rendering comprises segmenting the data 3D data set so that a specified body part is isolated.

19. The method of claim 18, wherein the body part is a heart or a portion thereof.

20. The method of claim 18, wherein a position of a catheter is determined by processing the live X-ray image, and a synthetic image of the catheter is added to the visualization.

21. The method of claim 18, where a viewing position attribute of the visualization is adjusted so that the viewing position is more distal from a surface of the body part than the position of the catheter.

22. The method of claim 19, wherein the 3D data set is obtained at a specified phase of the cardiac cycle, and the live X-ray image is obtained at the same specified phase of the cardiac cycle.

23. The method of claim 22, wherein the specified phase of the cardiac cycle is determined from electrocardiogram (EKG) data.

24. The method of claim 15, wherein a sequence of 3D data sets is recorded.

25. A system for displaying multi-modal data, the system comprising:
first means for recording data from a 3D imaging sensor;
second means for recording a live X-ray image;
means for simultaneously displaying a visualization image processed from data recorded by the first means for recording and the live image data recorded by the second means for recording.
